(19) United States
(12) Patent Application Publication
(10) Pub. No.: US 2016/0119154 A1
(43) Pub. Date: Apr. 28, 2016

(54) USAGE AND PERFORMANCE BASED BILLING

(71) Applicant: LiveQoS Inc., Ottawa (CA)

(72) Inventors: Matthew Robert Williams, Kanata (CA); Martin William Horne, Woodlawn (CA); Ryan Brink, Long Sault (CA); Stephane Brunet, Ottawa (CA); Scott Christopher Alan Jackson, Osgoode (CA); Geoffrey Longman, Greely (CA)

(21) Appl. No.: 14/921,272

(22) Filed: Oct. 23, 2015

Related U.S. Application Data
(60) Provisional application No. 62/067,650, filed on Oct. 23, 2014.

(51) Int. Cl. H04L 12/14; H04L 12/26; H04L 12/24

(52) U.S. Cl. CPC H04L 12/14; H04L 41/5029; H04L 43/087; H04L 43/0888

(57) ABSTRACT

A network performance-based billing method of billing for a plurality of file transmissions over a network comprises (1) selecting one or more performance improvement features associated with a service; (2) selecting a performance level associated with a bucket size representing the maximum number of bytes that can be transferred at the selected performance level; (3) selecting one or more parameters associated with each selected performance improvement feature; (4) selecting a target performance level to achieve for a selected file transmission; and (5) adjusting the selected parameters at the selected file transmission to achieve the selected performance level, wherein the bucket level associated with the selected performance level is depleted by the size of the transmitted file.

### CROSS-REFERENCE TO RELATED APPLICATIONS

This application claims the benefit of U.S. Provisional Application No. 62/067,650, filed Oct. 23, 2014, which is hereby incorporated by reference herein in its entirety.

### FIELD OF THE INVENTION

The present disclosure relates to network services billing.

### BRIEF SUMMARY

In accordance with one embodiment, a network performance-based billing method of billing for a plurality of file transmissions over a network comprises (1) selecting one or more performance improvement features associated with a service; (2) selecting a performance level associated with a bucket representing the maximum number of bytes that can be transferred at the selected performance level; (3) selecting one or more parameters associated with each selected performance improvement feature; (4) selecting a target performance level to achieve for a selected file transmission; and (5) adjusting the selected parameters at the selected file transmission to achieve the selected performance level, wherein the bucket associated with the selected performance level is depleted by the size of the transmitted file.

In one implementation, the performance improvement feature is the ratio of actual throughput to expected throughput for a selected file transmission over the network. The expected throughput may be a preselected data transfer rate, and the actual throughput may be a data transfer rate measured for the selected file transmission. The fee for the selected file transmission may be based on the value of the ratio for the selected file transmission. The expected throughput may be based on the file size of the selected file transmission.

In accordance with another embodiment, there is provided a network performance-based method of billing for data transmission over a network, said method comprising: providing a plurality of predetermined performance levels, each performance level defined by at least one value of a performance measure applicable to transmission of data; conducting the data transmission over said network; measuring a performance of said data transmission according to the performance measure to generate an actual performance value; determining for the data transmission an actual performance level with use of the actual performance value and definitions of the performance levels; and selecting a fee for said data transmission with use of said actual performance level.

Some embodiments further provide for providing a plurality of predetermined fee levels, each fee level corresponding to a performance level, wherein selecting a fee for said data transmission is performed with use of the predetermined fee level corresponding to the actual performance level. Some embodiments further provide for determining a target performance level for the data transmission prior to conducting the data transmission.

In some embodiments the target performance level is determined with use of at least one policy associated with the data transmission. In some embodiments the at least one policy defines target performance levels with use of at least one of application type, destination server, protocol, IP addresses, ports, size of data transmission, content of data transmission, file name, file type, user type, and user identity. In some embodiments the target performance level is determined with use of input from a user initiating the data transmission. In some embodiments the input is provided with use of at least one of a graphical user interface (GUI) and a command line interface (CLI). In some embodiments measuring a performance of the data transmission comprises measuring a temporary performance of the data transmission prior to completion of the data transmission to generate a temporary actual performance value, the method further comprising: determining for the data transmission a temporary actual performance level with use of the temporary actual performance value and the definitions of the performance levels; determining whether the temporary actual performance level matches the target performance level; and in a case where the temporary actual performance level is less than the target performance level, increasing the performance improvement function, and in a case where the temporary actual performance level is greater than the target performance level, throttling the performance improvement function down. In some embodiments throttling a performance function up comprises increasing the performance improvement function in order to reach the target performance level by completion of the data transmission.

Some embodiments further provide for determining for each performance level a bucket size representing a predetermined magnitude of data for transmission of data at the performance level during a predetermined period of time; tracking for each performance level a current bucket level starting at the bucket size at the beginning of the predetermined period of time; and subsequent to completion of the data transmission, decrementing the current bucket level corresponding to the actual performance level by a size of the data transmission. Some embodiments further provide for sending a notice to initiate the replenishment of a current bucket level in a case where the current bucket level falls below a predetermined threshold corresponding to the current bucket level being nearly depleted. Some embodiments further provide for determining for each performance level a bucket size representing a predetermined magnitude of data for transmission of data at the performance level during a predetermined period of time; tracking for each performance level a corresponding current bucket level starting at the bucket size at the beginning of the predetermined period of time; subsequent to completion of the data transmission, decrementing the current bucket level corresponding to the actual performance level by a size of the data transmission, wherein the at least one policy defines the target performance level with use of the current bucket levels of each performance level.

In some embodiments the at least one policy defines the target performance level as the highest performance level having a corresponding current bucket level which exceeds a target bucket level threshold. In some embodiments the at least one policy defines the target performance level as other than a performance level for which the corresponding current bucket level has been depleted. In some embodiments the performance measure comprises a measure of at least one of throughput, delay, and jitter. In some embodiments the performance measure comprises a measure of a ratio of at least one of throughput, delay, and jitter. In some embodiments the performance measure comprises a ratio of an actual throughput to an expected throughput. In some embodiments the actual throughput is a throughput measured for the data transmission once completed and the expected throughput is a throughput calculated prior to the data transmission. In some embodiments the expected throughput is calculated from a magnitude of the data transmission and a current state of the network.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is a flow chart of a method of usage and performance-based billing.

FIG. 2 is a flow chart of a method of performance-based billing for a plurality of file transmissions over a network.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Network services for data transfer are now common consumer and business product offerings. Users (business or consumer) subscribe to a data transfer service or internet service which may include some level of usage-based billing, wherein the service provider charges a monthly fee based on both the amount of data transferred within the month and the level of network bandwidth provided. Often a basic fee is billed for access at a given bandwidth for amounts of data below a certain data usage limit for a usage period along with usage fees based on the amount of data transferred above that limit during the usage period.

Service providers are now offering services with performance improvement features. Such services include, for example, acceleration of data transfers in networks that are subject to loss using encoding schemes such as the one described in U.S. Pat. No. 7,742,501. Service providers typically bill for these improved services at a predetermined premium rate. Since the performance improvements achieved with such schemes are variable, it is difficult to bill according to the performance actually achieved, which would be highly desirable.

In one embodiment, the service provider computes, for each data transfer, the Expected Throughput (ET) which would be achieved assuming no performance improvement functions are implemented. The ET is then compared with the Actual Throughput (AT) measured for the data transfer.

Based on this information, a tiered pricing model can be offered, wherein a given price is offered when no performance achievement is obtained, and a different price can be offered as a function of the performance achievement reached.

In one example, a tiered pricing model of three performance levels can be offered for which a Performance Ratio (PR) can be computed as a ratio of AT/ET and used to determine the pricing. If PR is less than 1, then the price per kilobyte (KB) of transmission is set to the price corresponding to performance level 1; if the PR is between 1 and 3, then the price per KB of transmission is set to a higher price which corresponds to performance level 2; and if the PR is greater than 3, the price per KB of transmission is set to the highest price which corresponds to performance level 3. Any number of levels can be used for the pricing model, and the incremental price increases based on the performance level can be predetermined by the service provider and offered to the user. Alternatively, any equation that can derive a performance ratio based on an AT/ET ratio can be used. Generally, each performance level corresponds to or is defined by a range of performance ratios.

Each time a file transfer is initiated, the ET is estimated, generally based on the file size (FS) and the current conditions and capacity of the network. When the file transfer is completed, the AT is computed and then the PR is computed from the ET and AT, and the result is logged in the user's database (e.g., FS kilobytes were transferred at level 1). The billing can be performed periodically based on the amount of data transferred at the different performance levels.

The ET may depend on the protocol used for the file transfer. For some protocols, the ET is determined by testing and heuristics and stored in a lookup table as a function of FS and optionally transmission speed, if that is not fixed for a user.

In the case of some protocols, such as Transmission Control Protocol (TCP), the ET can be computed based on mathematical models, such as those described in Padhye Jitendra et al., Modeling TCP Throughput: A simple model and its empirical validation, ACM SIGCOMM. 1998; and International Telecommunication Union, Series G: Transmission systems and media, digital systems and networks, Estimating end-to-end performance in IP networks for data applications, ITU-T G.1030, November 2005, section 1.4.2.

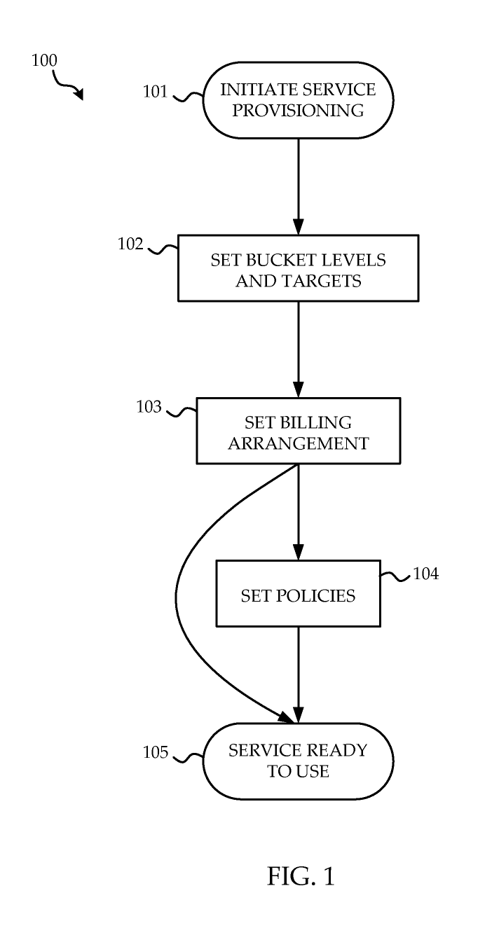

Referring to FIG. 1, a method of usage and performance-based billing 100 according to one embodiment will now be described. A service provisioning request initiates service provisioning at step 101. The service provider sets up the performance levels along with the corresponding bucket levels which represent the remaining available amount of data to be transmitted at each performance level, and target performance levels at step 102. It should be understood that the term “bucket” here is used to track the remaining amount of remaining available data allocated for usage for a performance level. The “bucket size” corresponds to the predetermined limited amount, while a “bucket level” denotes the amount of usage remaining, i.e. the “bucket size” minus the current total amount of usage thus far at that performance level. When the data usage at a performance level reaches the predetermined limit the “bucket” for that level is said to be depleted and if more data is allocated for a performance level, the “bucket” at that level is said to be “replenished.” The billing arrangements are set at step 103. The service follows a pre-paid model wherein a predetermined limited amount of bandwidth is prepaid for each performance level, and notices are sent when the amount of bandwidth at a given performance level is nearly depleted, to initiate the replenishment of the buckets at each performance level where needed. In the absence of replenishment and if the bucket is depleted i.e. all of the predetermined limited amount of bandwidth for a performance level is consumed, the remaining other performance levels can be used for subsequent transmission. Alternatively, regular billings can be sent to request payments for the actual amount of bandwidth transmitted at each performance level, and there may not be a limit on the amount that can be transmitted for any given performance level.

The pricing model can also be used by a group of people, in which case the predetermined limited amount of bandwidth at each performance level can be shared among several users. Priorities can be assigned to users to access the fastest levels.

Policies may also be optionally set at step 104. A policy engine can be used to select the performance level for transmission of data based on one or more of the following: application type, destination server, protocol, IP addresses, ports, size of file, file content, file name, file type, user type or user identity. Another option is to select the performance level of transmission via explicit customer control through a Graphical User Interface (GUI) or Command Line Interface (CLI). Applications can optionally be designed to request a given level of performance. Although the performance improvement achieved cannot always be guaranteed, the performance improvement schemes can be tuned to attempt to achieve the requested performance level.

Once the service is provisioned, the file transmissions can be initiated at step 105.

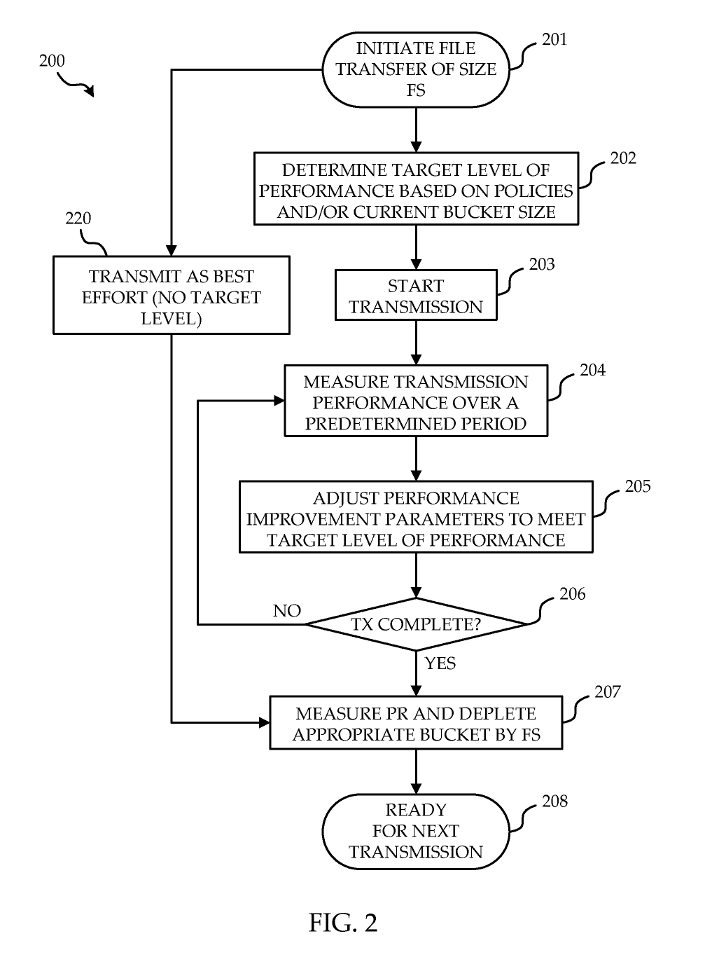

Referring to FIG. 2, a method of performance-based billing for a plurality of file transmissions over a network 200 according to one embodiment will now be described. When a file transfer of size FS is initiated at step 201, the target file transfer performance level can be determined based on policies and/or current bucket size at step 202, or based on the current levels in the buckets (i.e. the bucket size minus the amount of data already transmitted at that performance level) at step 202. For example, the highest performance level with a large enough remaining bucket i.e. large enough bucket level exceeding a target bucket level threshold, may be selected for the transfer. Once the Target Level (TL) is set, the file transfer is initiated at step 203, and the performance (AT) is measured for a predetermined period at step 204 (e.g., a short time or until a percentage of the file is transmitted) and a temporary PR is calculated. If the temporary PR corresponds to a performance level which exceeds the target level, the performance improvement function throttles down 205. If the temporary PR corresponds to a performance level which is below the target level, the performance improvement function attempts to increase the performance in order to reach the target level by the end of the file transmission at step 205. When step 206 determines that the file transfer is determined to be completed, the PR is estimated, the performance level corresponding to that PR is determined, and the appropriate bucket for that performance level is depleted at step 208.

As another embodiment, there may be no target performance level and the service attempts to deliver as fast as possible on a best effort basis at step 220. When step 206 determines that the file is transmitted completely, the PR is computed and the appropriate bucket for the performance level is depleted by FS at step 207.

In another embodiment, the user has the option to limit the amount of data transferred at a given level of performance to control the overall pricing. The user can optionally limit how many levels of performance improvements the user wants to achieve. So the pricing model varies depending on how many levels are offered to a user.

The ET and AT can also be any performance measures such as delay or jitter, or can be measured as a combination of several performance measures, and the performance levels may be based upon or defined by any of these performance measures whether in a form based on ratios thereof or based on absolute values thereof

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A network performance-based method of billing for data transmission over a network, said method comprising:
providing a plurality of predetermined performance levels, each performance level defined by at least one value of a performance measure applicable to transmission of data;
conducting the data transmission over said network;
measuring a performance of said data transmission according to the performance measure to generate an actual performance value;
determining for the data transmission an actual performance level with use of the actual performance value and definitions of the performance levels; and
selecting a fee for said data transmission with use of said actual performance level.

2. The method of claim 1 further comprising:
providing a plurality of predetermined fee levels, each fee level corresponding to a performance level,
wherein selecting a fee for said data transmission is performed with use of the predetermined fee level corresponding to the actual performance level.

3. The method of claim 1 further comprising:
determining a target performance level for the data transmission prior to conducting the data transmission.

4. The method of claim 3 wherein the target performance level is determined with use of at least one policy associated with the data transmission.

5. The method of claim 4 wherein the at least one policy defines target performance levels with use of at least one of application type, destination server, protocol, IP addresses, ports, size of data transmission, content of data transmission, file name, file type, user type, and user identity.

6. The method of claim 3 wherein the target performance level is determined with use of input from a user initiating the data transmission.

7. The method of claim 6 wherein the input is provided with use of at least one of a graphical user interface (GUI) and a command line interface (CLI).

8. The method of claim 3 wherein measuring a performance of the data transmission comprises measuring a temporary performance of the data transmission prior to completion of the data transmission to generate a temporary actual performance value, the method further comprising:
determining for the data transmission a temporary actual performance level with use of the temporary actual performance value and the definitions of the performance levels;
determining whether the temporary actual performance level matches the target performance level; and
in a case where the temporary actual performance level is less than the target performance level, increasing the performance improvement function, and in a case where the temporary actual performance level is greater than the target performance level, throttling the performance improvement function down.

9. The method of claim 8 wherein, throttling a performance function up comprises increasing the performance improvement function in order to reach the target performance level by completion of the data transmission.

10. The method of claim 1 further comprising:
determining for each performance level a bucket size representing a predetermined magnitude of data for transmission of data at the performance level during a predetermined period of time;
tracking for each performance level a current bucket level starting at the bucket size at the beginning of the predetermined period of time; and
subsequent to completion of the data transmission, decrementing the current bucket level corresponding to the actual performance level by a size of the data transmission.

11. The method of claim 10 further comprising:
sending a notice to initiate the replenishment of a current bucket level in a case where the current bucket level falls below a predetermined threshold corresponding to the current bucket level being nearly depleted.

12. The method of claim 4 further comprising:
determining for each performance level a bucket size representing a predetermined magnitude of data for transmission of data at the performance level during a predetermined period of time;
tracking for each performance level a corresponding current bucket level starting at the bucket size at the beginning of the predetermined period of time;
subsequent to completion of the data transmission, decrementing the current bucket level corresponding to the actual performance level by a size of the data transmission, wherein the at least one policy defines the target performance level with use of the current bucket levels of each performance level.

13. The method of claim 12 wherein the at least one policy defines the target performance level as the highest performance level having a corresponding current bucket level which exceeds a target bucket level threshold.

14. The method of claim 12 wherein the at least one policy defines the target performance level as other than a performance level for which the corresponding current bucket level has been depleted.

15. The method of claim 1 wherein the performance measure comprises a measure of at least one of throughput, delay, and jitter.

16. The method of claim 1 wherein the performance measure comprises a measure of a ratio of at least one of throughput, delay, and jitter.

17. The method of claim 1 wherein the performance measure comprises a ratio of an actual throughput to an expected throughput.

18. The method of claim 17 wherein the actual throughput is a throughput measured for the data transmission once completed and the expected throughput is a throughput calculated prior to the data transmission.

19. The method of claim 18 wherein the expected throughput is calculated from a magnitude of the data transmission and a current state of the network.
